(19) United States
(12) Patent Application Publication
(10) Pub. No.: US 2026/0243277 A1
(43) Pub. Date: Aug. 20, 2026

(54) MAGNETIC SUCTION FAN

(71) Applicant: Shenzhen Giikfun Technology Co., Ltd., Shenzhen (CN)

(72) Inventor: Ning XU, Shenzhen City (CN)

(73) Assignee: Shenzhen Giikfun Technology Co., Ltd., Shenzhen (CN)

(21) Appl. No.: 19/648,129

(22) Filed: Apr. 15, 2026

Related U.S. Application Data
(63) Continuation-in-part of application No. 19/294,260, filed on Aug. 7, 2025.

(51) Int. Cl. F04D 29/64; F04D 29/52; H01F 1/057

(52) U.S. Cl. CPC F04D 29/646; F04D 29/522; H01F 1/057

(57) ABSTRACT

A magnetic suction fan, including: a fan assembly, a base, and a magnetic element. The fan assembly is configured to convert electrical energy into mechanical energy to generate airflow. The base rigidly is fixed to the fan assembly. The magnetic element exposed on the base, configured to magnetically secure the base to a ferromagnetic surface. The magnetic element includes a magnetic working surface with a magnetic attraction force sufficient to maintain the base fixed under vibration conditions. During use, a magnetic attraction force working surface provides a planar pulling force. The base is rigidly connected with the fan assembly to ensure that vibration energy is isolated by the base-magnetic attraction system and prevented from being transmitted to the fan assembly. The fan assembly continuously converts electrical energy into uniform and strong airflow, thereby providing operators with a cool and comfortable airflow supply experience.

### CROSS-REFERENCE TO RELATED APPLICATIONS

This application is a continuation in part application of application number 19/294,260, filed August 7, 2025, the entire disclosure of which is hereby incorporated by reference.

### TECHNICAL FIELD

The present disclosure relates to the technical field of portable fans, in particular to a highly vibration-resistant magnetic suction fan for use in vibration conditions.

### BACKGROUND

In outdoor sports and various vibration environments, such as scenarios in which golf carts, off-road vehicles, agricultural machinery, vehicle-mounted equipment, and the like are subjected to long-term bumping and jolting, fans, as commonly used accessories for relieving stuffiness and heat, generally have defects in their fixing manners. Although conventional strap winding or mechanical clamps are widely adopted, under continuous vibration—for example, when a vehicle travels on a grassy slope or a gravel road, or when equipment operates on uneven ground-the straps are prone to loosening and the clamps are prone to displacement, causing the magnetic suction fan to shake or even fall off, thereby requiring frequent shutdowns for adjustment. Although a small number of magnetic suction fans simplify the installation process, the magnetic attraction force of their magnets is generally insufficient (typically less than 5 kg), and it is difficult for them to withstand high-frequency vibration impacts, such that the risk of fixing failure remains prominent.

The above problems seriously affect user experience: an insecurely fixed fan not only reduces airflow supply efficiency, but may also accidentally fall during jolting, thereby causing equipment damage or safety hazards.

### SUMMARY

In order to overcome the deficiencies of the prior art, the present disclosure provides a magnetic suction fan, which has a simple structure and can effectively solve the problem of reliable fixing in a vibration environment.

To realize the above objective, the present disclosure provides a magnetic suction fan, including: a fan assembly, a base, and a magnetic element.

The fan assembly is configured to convert electrical energy into mechanical energy to generate airflow.

The base is rigidly fixed to the fan assembly.

The magnetic element exposed on the base, configured to magnetically secure the base to a ferromagnetic surface.

The magnetic element includes a magnetic working surface with a magnetic attraction force sufficient to maintain the base fixed under vibration conditions.

The beneficial effects of the present disclosure are as follows: during use, a magnetic attraction force working surface of the magnetic element provides a planar pulling force greater than 10 kg, such that the base is firmly adsorbed onto a ferromagnetic surface of equipment in a vibration environment, such as metal mounting surfaces of golf carts, engineering machinery, agricultural vehicles, off-road vehicles, vehicle-mounted equipment, and the like. Even under continuous bumping, vibration, or impact, the base can still be maintained in a zero-displacement fixed state, thereby completely solving the risk of falling off caused by loosening of conventional straps or failure of magnetic attraction. The base is rigidly connected with the fan assembly, so as to ensure that vibration energy is isolated by the base-magnetic attraction system and prevented from being transmitted to the fan assembly so as to affect the stability of airflow supply. The fan assembly continuously converts electrical energy into uniform and strong airflow, thereby providing operators with a cool and comfortable airflow supply experience and significantly improving the continuous working capability and thermal comfort of various workers in high-temperature environments.

### BRIEF DESCRIPTION OF DRAWINGS

In order to more clearly illustrate the technical solutions in the embodiments of the present disclosure, the drawings required for the description of the embodiments will be briefly introduced below. The drawings described below merely illustrate some embodiments of the present disclosure, and those of ordinary skill in the art may derive other drawings therefrom without creative efforts.

The present disclosure is further described below in conjunction with the accompanying drawings and embodiments.

FIG. 1 is a schematic diagram of a magnetic suction fan according to a first embodiment of the present disclosure from a first angle.

FIG. 2 is a schematic diagram of the magnetic suction fan according to the first embodiment of the present disclosure from a second angle.

FIG. 3 is a cross-sectional view of the magnetic suction fan according to the first embodiment of the present disclosure.

FIG. 4 is an exploded view of the magnetic suction fan according to the first embodiment of the present disclosure from the first angle.

FIG. 5 is an exploded view of the magnetic suction fan according to the first embodiment of the present disclosure from the second angle.

FIG. 6 is an exploded view of a fan body of the magnetic suction fan according to the first embodiment of the present disclosure from the first angle.

FIG. 7 is an exploded view of the fan body of the magnetic suction fan according to the first embodiment of the present disclosure from the second angle.

FIG. 8 is a schematic diagram of a magnetic suction fan according to a second embodiment of the present disclosure.

FIG. 9 is an exploded view of the magnetic suction fan according to the second embodiment of the present disclosure.

FIG. 10 is a schematic diagram of a magnetic suction fan according to a third embodiment of the present disclosure from a first angle.

FIG. 11 is a schematic diagram of the magnetic suction fan according to the third embodiment of the present disclosure from a second angle.

FIG. 12 is an exploded view of the magnetic suction fan according to the third embodiment of the present disclosure.

### Description of the reference numerals

100 fan assembly, 200 base, 300 magnetic element, 400 connecting element, 110 fan bracket, 111 bracket installation portion, 120 fan body, 121 fan snap-fit portion, 122 mating snap-fit portion, 123 control circuit board, 124 rechargeable power supply, 125 charging port, 126 discharge port, 127 control button, 128 light strip, 129 motor, 1210 fan blade, 210 installation groove, 211 connecting through hole, 2111 nut installation groove, 212 connecting protrusion, 2121 blind hole, 220 fan installation part, 230 fan clamp body, 240 anti-slip element, 241 installation surface, 242 anti-slip surface, 310 magnetic working surface, 320 installation through hole, 410 threaded fastener, 420 connecting nut.

### DETAILED DESCRIPTION OF THE EMBODIMENTS

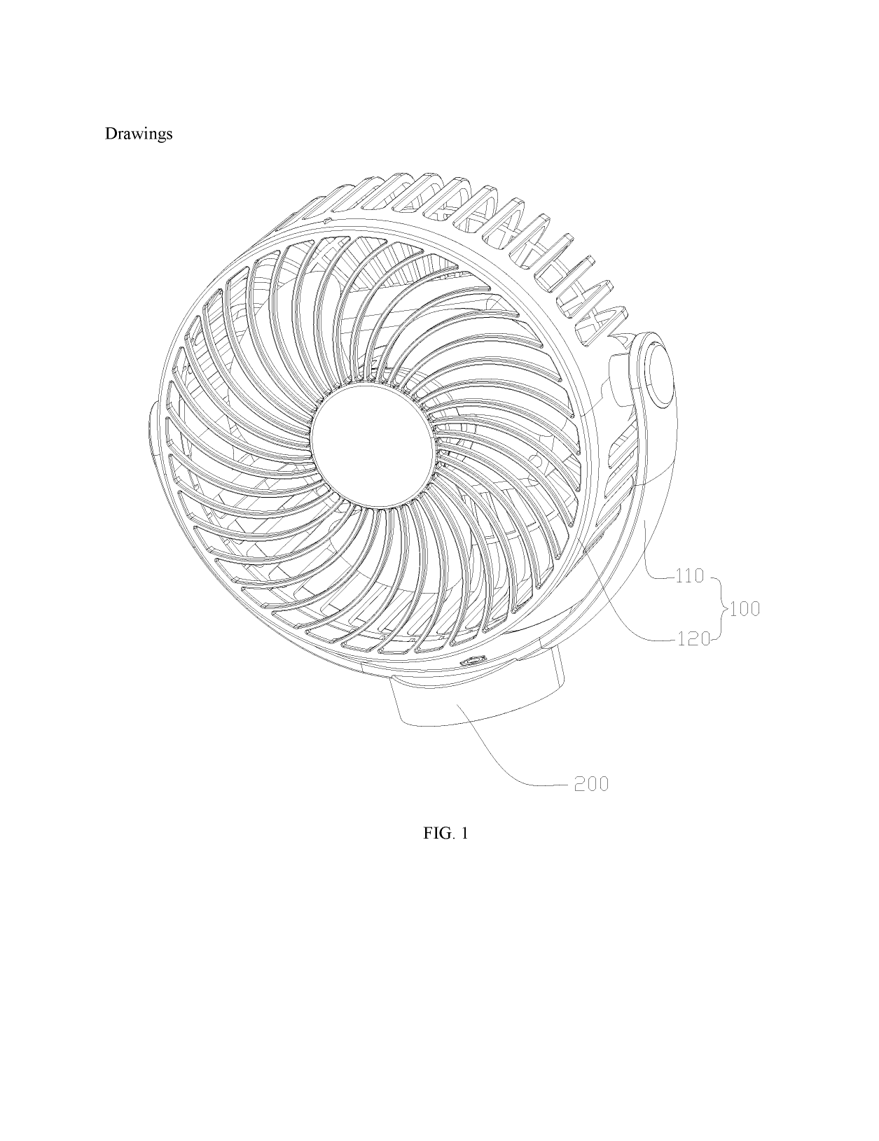

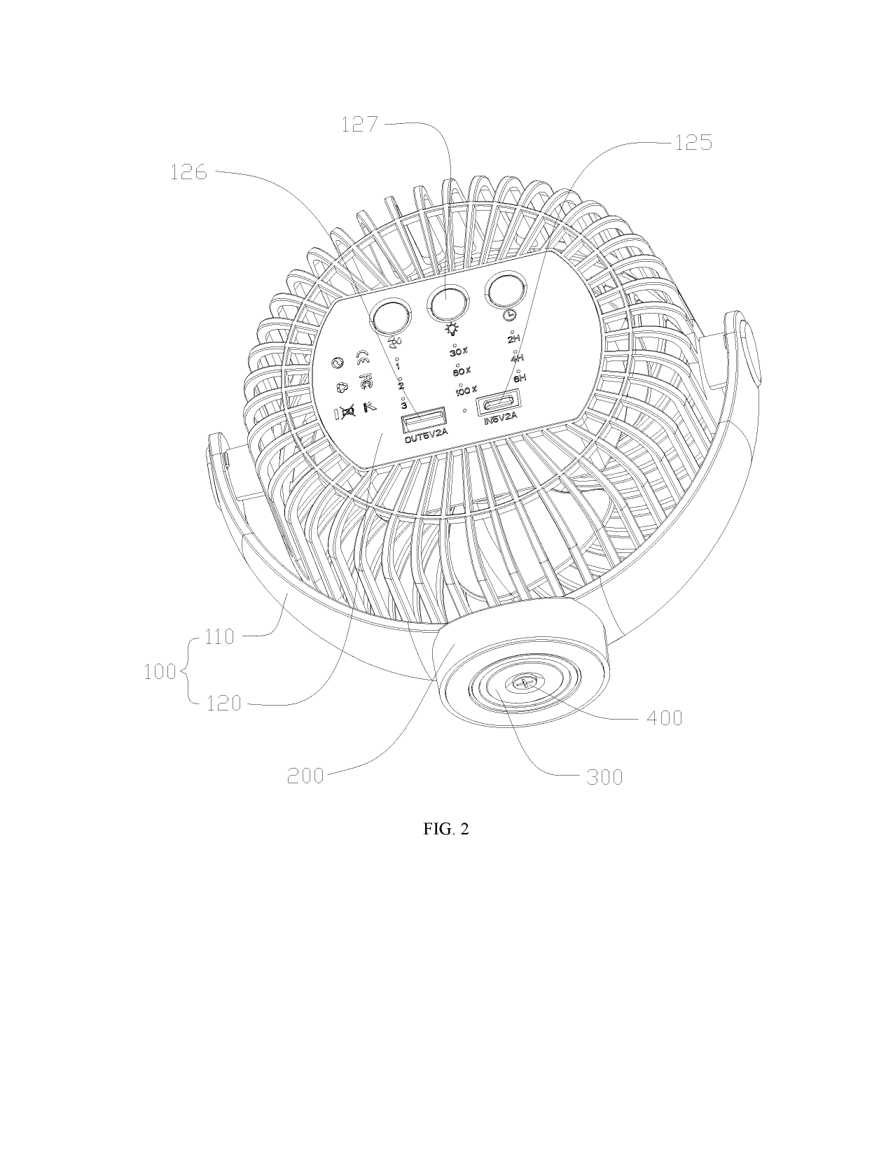

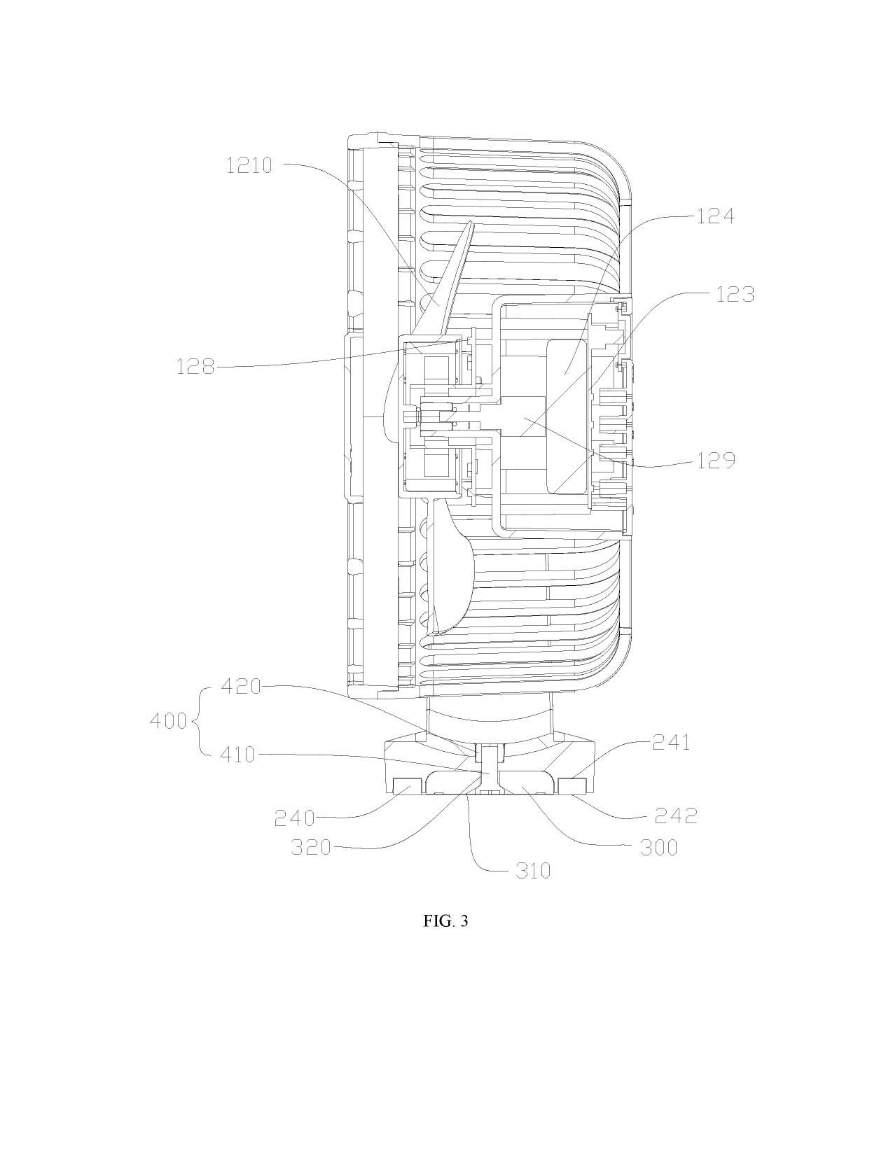

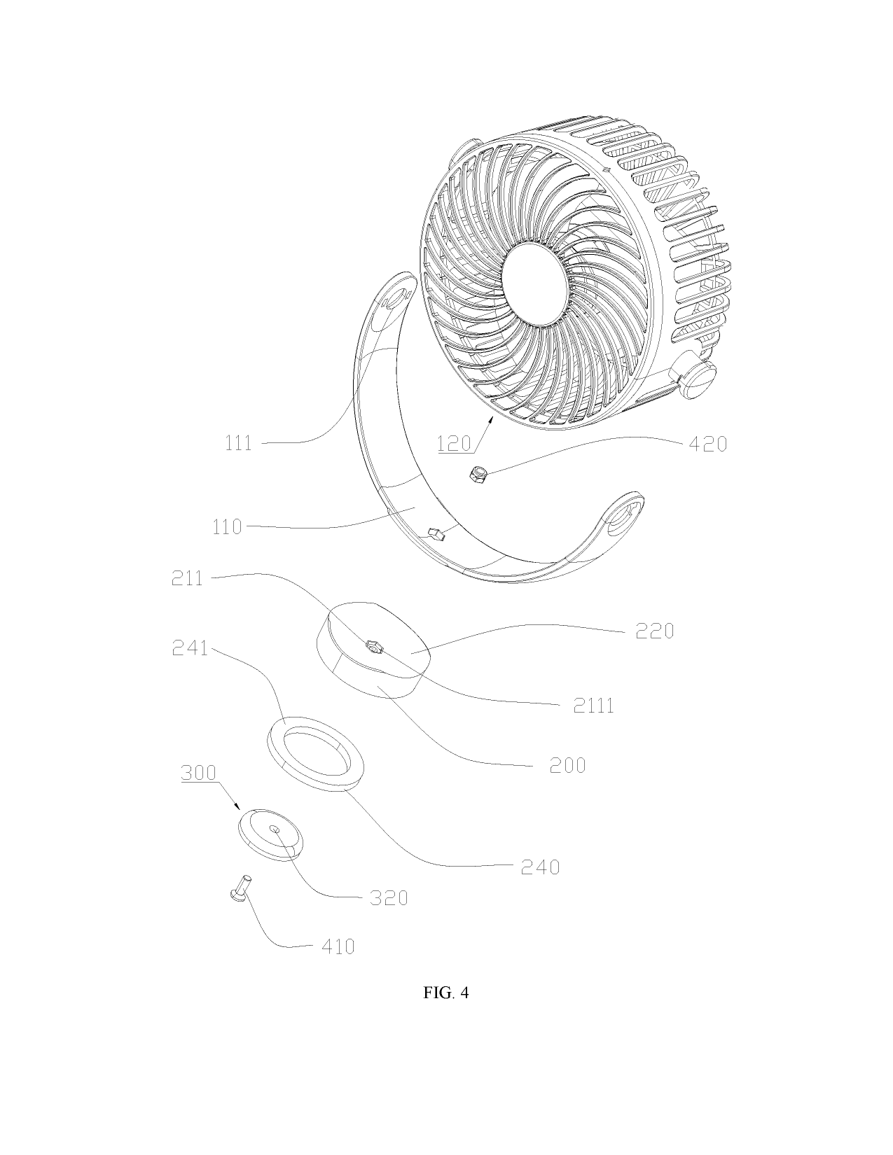

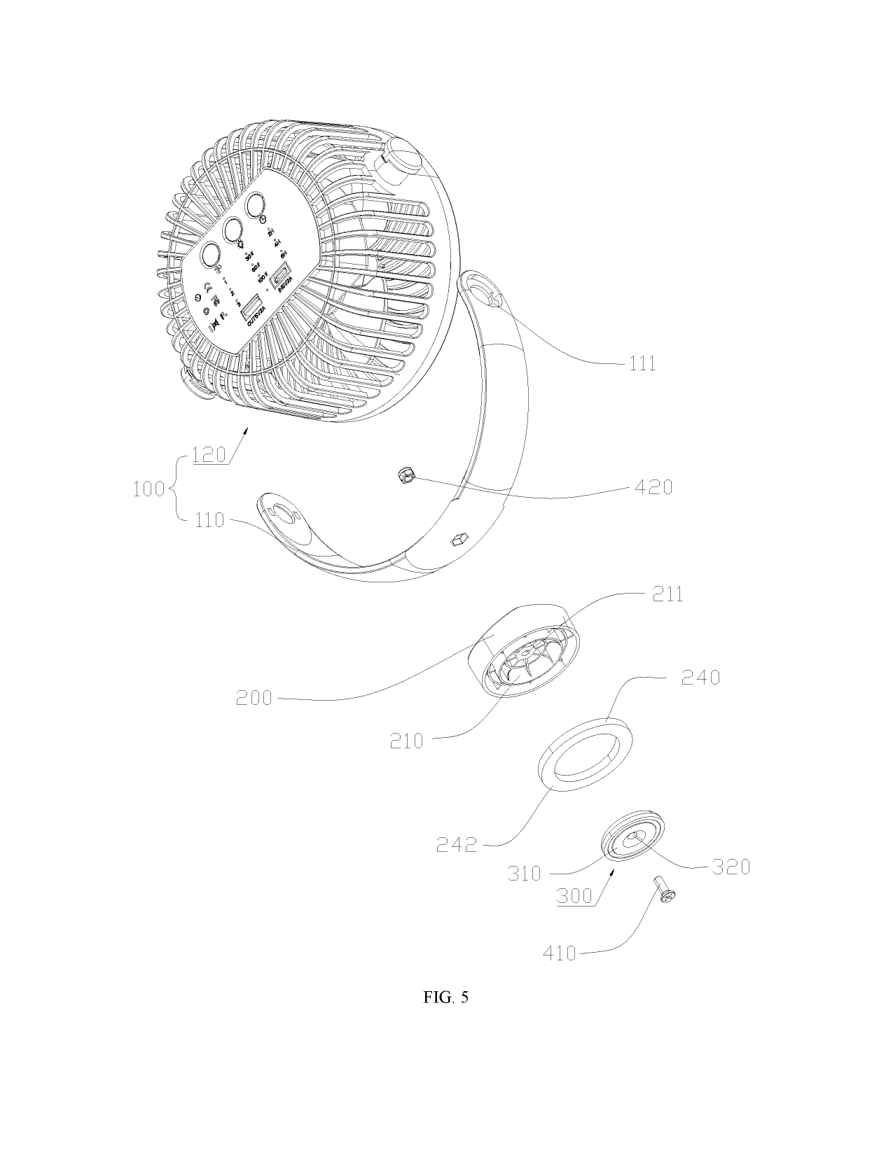

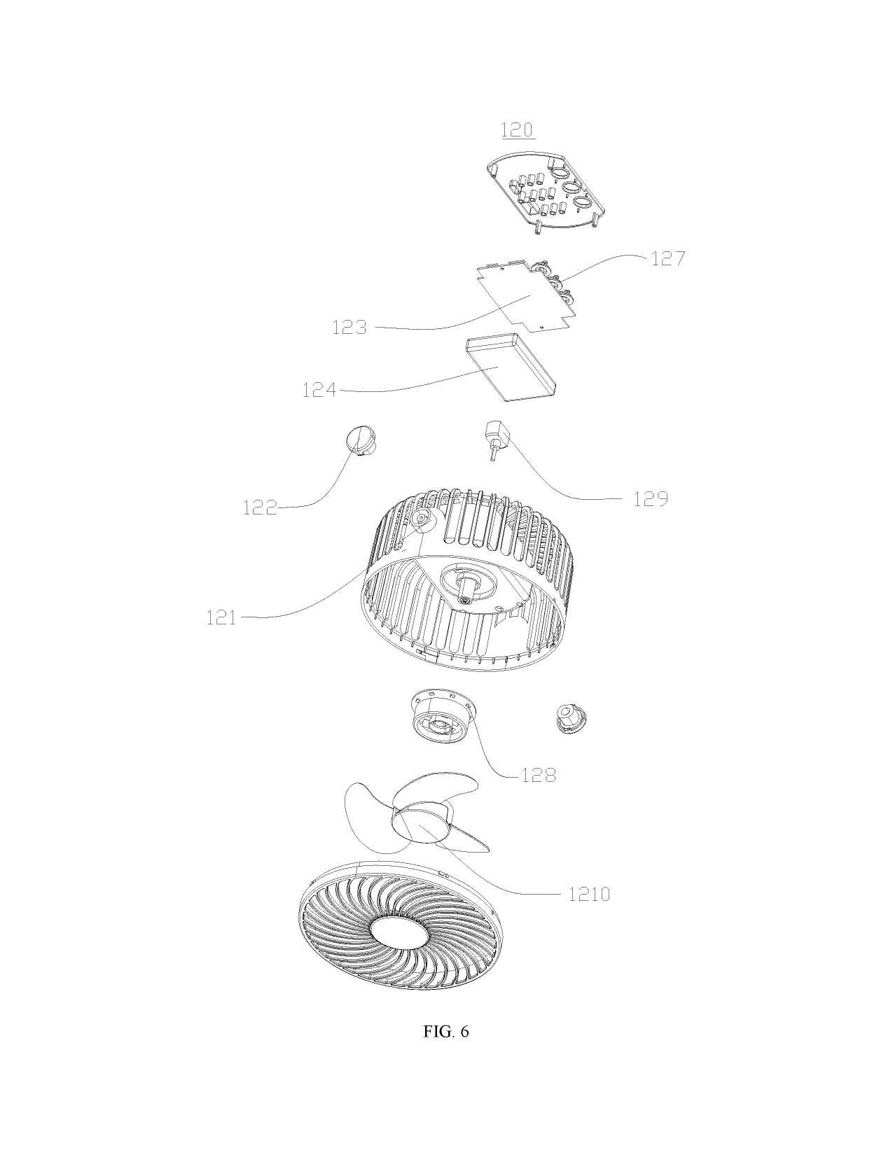

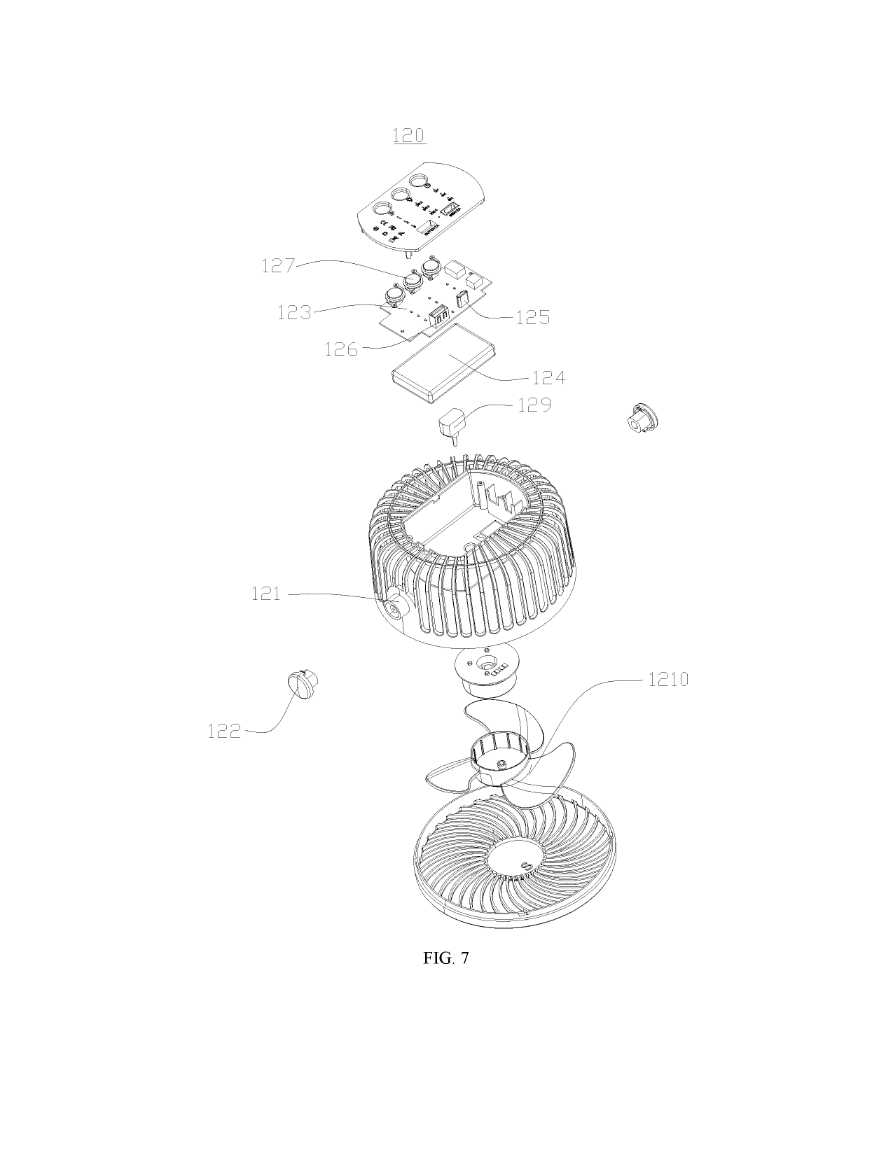

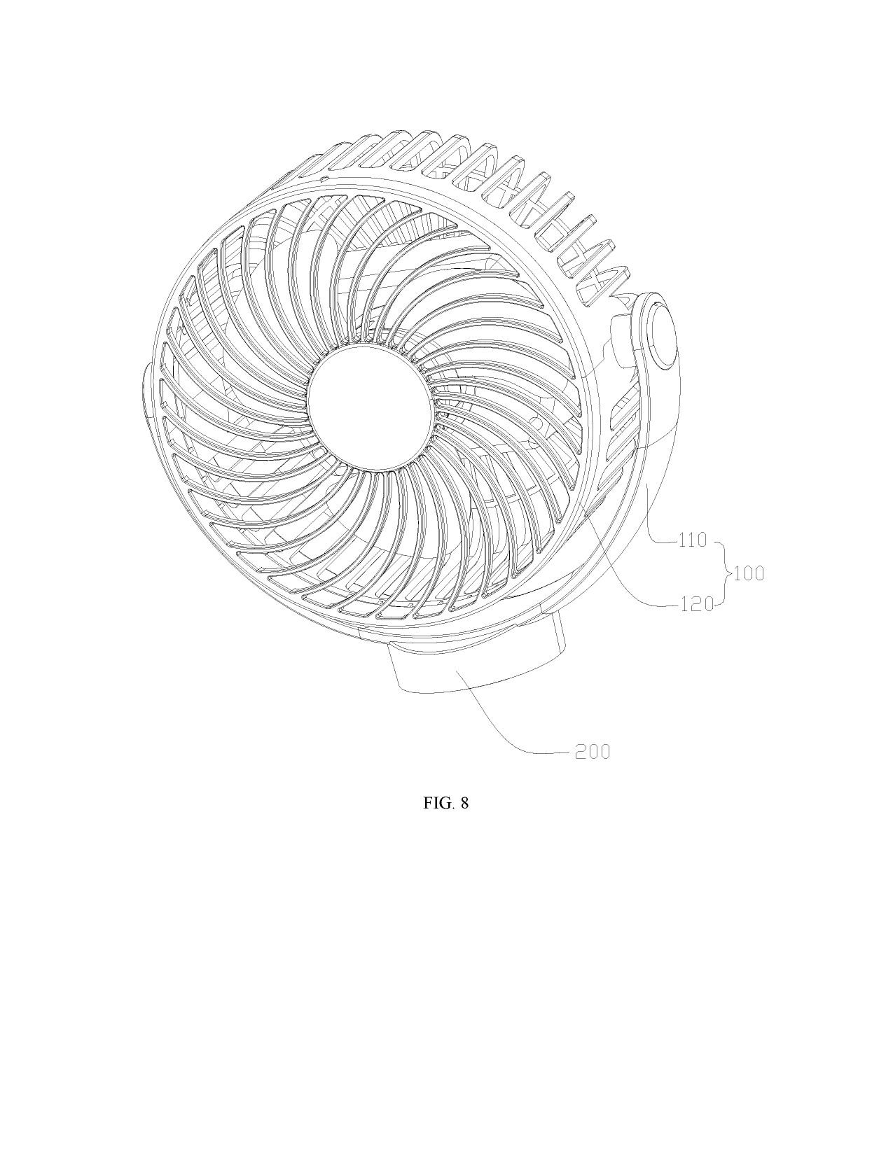

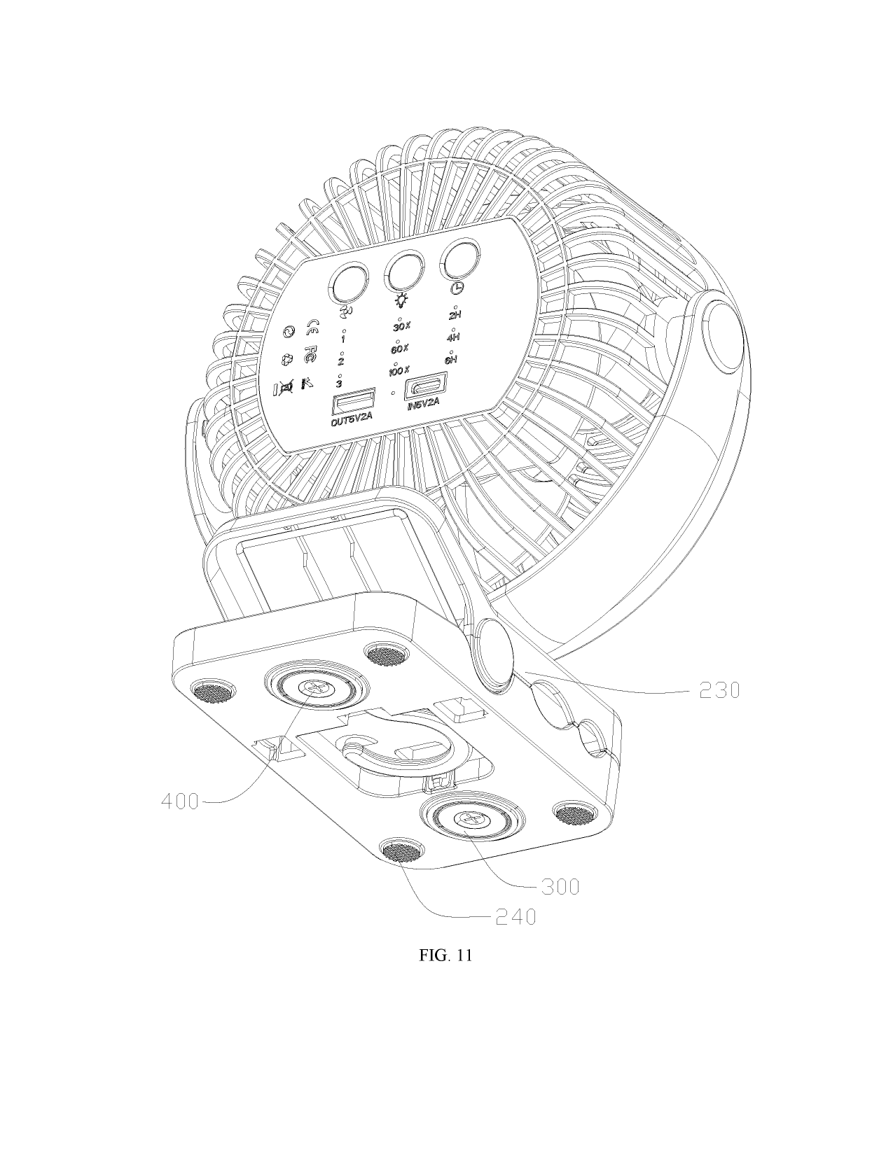

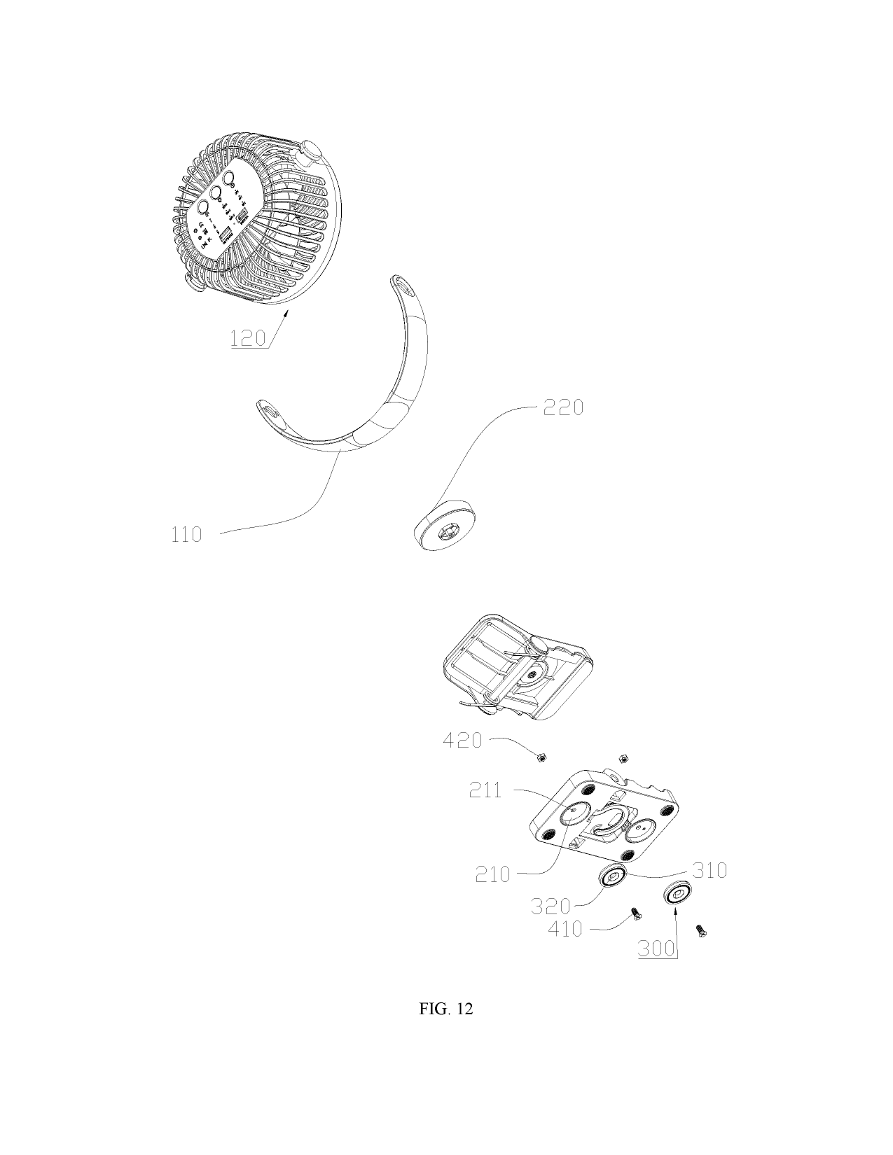

Referring to FIGS. 1-12, a magnetic suction fan includes a fan assembly 100, a base 200, a magnetic element 300, and a connecting element 400. The following description first details the first embodiment (FIGS. 1-7), followed by brief descriptions of the second and third embodiments (FIGS. 8-9 and 10-12, respectively).

The fan assembly 100 is configured to convert electrical energy into mechanical energy to generate airflow. The base 200 is rigidly fixed to the fan assembly 100. The magnetic element 300 is exposed on the base 200 and is configured to magnetically secure the base 200 to a ferromagnetic surface. The magnetic element 300 includes a magnetic working surface 310 that provides a magnetic attraction force sufficient to maintain the base 200 fixed under vibration conditions.

Referring to the arrangement described above, during use, the magnetic working surface 310 of the magnetic element 300 is configured with a strong magnetic arrangement (testing shows that providing a pull force greater than 10 kg on a flat surface achieves optimal results), firmly attaching the base 200 to the ferromagnetic surface of equipment under the vibration conditions (e.g., metal mounting surfaces of golf carts, construction machinery, off-road vehicles, agricultural equipment, and in-vehicle equipment) even under vibrating environments, such as rough roads or shocks. The base 200 remains fixed with zero displacement. The base 200 is rigidly fixed to the fan assembly 100, so vibration energy is isolated and absorbed by the base-magnetic element system, preventing it from being transmitted to the fan assembly 100. The rigid connection between the base 200 and the fan assembly 100 forms a rigid body with no relative displacement. When vibration from the equipment in the vibrating conditions is transmitted to the magnetic element 300 via the ferromagnetic surface, the vibration energy is first directed into the base 200. Based on the principle of mechanical impedance mismatch, most of the vibration energy is reflected at the connection interface. The residual energy is converted into heat energy through the high damping properties of the base -magnetic element composite (magnetic domain wall motion and internal friction of the material), dissipating the energy. This design reduces the vibration transmission rate in the typical oscillation frequency range of 5-50 Hz to 0.15-0.4 (reducing by 60%-85% compared to flexible connections), ensuring that vibration energy is isolated and absorbed, preventing it from being transmitted to the fan assembly 100, which could lead to loosen parts or airflow instability. The fan assembly 100 continuously converts electrical energy into mechanical energy that drives air flow, outputting a stable and strong airflow, providing a cool and comfortable airflow supply for operators under the vibration conditions. It should be noted that the exposed magnetic working surface 310 directly forms a tight fit with the ferromagnetic surface of the equipment under the vibrating conditions with no layer or gap in between, thus avoiding additional magnetic resistance introduced by plastic or rubber coverings in traditional encased magnets, ensuring magnetic lines penetrate the working interface with minimal loss and achieving a pull force greater than 10 kg on the flat surface.

In this embodiment, the base 200 is provided with an installation groove 210, the installation groove 210 whose shape matches the outer contour of the magnetic element 300. The magnetic element 300 is embedded into the installation groove 210 and fixedly connected thereto. With the configuration described above, during installation, the magnetic element 300 is precisely embedded into the installation groove 210 of the base 200, enabling quick positioning by shape matching and avoiding manual alignment. During use, the installation groove 210 forms circumferential constraints on the magnetic element 300, preventing micro-displacement of the magnetic element 300 on the base 200 under vibrating environments ensuring that the magnetic working surface 310 maintains full contact with the ferromagnetic surface of the equipment in the vibrating conditions. The fixed connection ensures that the magnetic element 300 and the base 200 form a rigid whole, resisting vibration shocks under the vibrating conditions maintaining a persistent adsorption effect with a pull force greater than 10 kg on the flat surface, and reducing the risk of the magnetic suction fan detaching. It should be noted that in this embodiment, the magnetic working surface 310 of the magnetic element 300 is described with a circular outer contour, but its shape is not limited to this and may be set to other geometries, such as square, depending on actual needs.

The magnetic suction fan further includes a connecting element 400, the magnetic element 300 is fixedly installed in the installation groove 210 via the connecting element 400. With this configuration, during installation, the connecting element 400 quickly installs the magnetic element 300 into the installation groove 210 without requiring adhesive curing, improving assembly efficiency. During use, the connecting element 400 applies continuous pre-tension to the magnetic element 300, eliminating assembly gaps between the base 200 and the magnetic element 300, ensuring they maintain a rigid, integral state under the vibration conditions and ensuring stable transmission of the pull force greater than 10 kg. During maintenance, disassembling the connecting element 400 allows separation of the magnetic element 300 from the base 200, enabling modular replacement or upgrade of the magnet, significantly reducing later maintenance costs. The connecting element 400, through its three-stage design (mechanical immediate fixing during installation, pre-tension resistance to vibration during use, and modular disassembly during maintenance), ensures reliable adsorption greater than 10 kg under vibrating environments while simultaneously enhancing production efficiency and maintenance economy, perfectly meeting the high-frequency maintenance needs of components in vibrating conditions.

In this embodiment, the magnetic element 300 is provided with a mounting through hole 320, the connecting element 400 passes through the mounting through hole 320 and is fixedly connected to the installation groove 210. With the configuration described above, during assembly, the mounting through hole 320 provides an accurate passage for the connecting element 400, allowing quick alignment of the magnetic element 300 with the installation groove 210 and eliminating manual adjustment errors. During use, the radial constraint force generated by the connecting element 400 passing through the mounting through hole 320 suppresses circumferential micro-movement of the magnetic element 300 under vibration, while the axial locking force ensures the magnetic working surface 310 remains in close contact with the base 200, ensuring that the pull force greater than 10 kg is transmitted without loss to the ferromagnetic surface in the vibrating conditions. During maintenance, the connecting element 400 can be disassembled from the mounting through hole 320 in reverse, enabling non-destructive replacement of the magnetic element 300 and avoiding the risk of magnet breakage caused by traditional adhesive methods.

In this embodiment, a bottom of the installation groove 210 is provided with a connecting through hole 211, the connecting element 400 passes through the mounting through hole 320 and the connecting through hole 211, and is threadedly fastened to secure the magnetic element 300 to the installation groove 210. With this configuration, during assembly, the connecting element 400 passes through the mounting through hole 320 of the magnetic element 300 and the connecting through hole 211 at the bottom of the installation groove 210, and is locked by screw-tightening for single-point operation, without requiring auxiliary fixtures for positioning. During use, the axial pre-tension generated by the screw-tightening makes the magnetic element 300 tightly compressed against the bottom surface of the installation groove 210, eliminating impact noise caused by micro-gaps under the vibrating environments while the coaxial constraint of the dual through holes suppresses circumferential rotation of the magnet, ensuring that the magnetic working surface 310 remains in full contact with the ferromagnetic surface in the vibrating condition. During maintenance, the connecting element 400 can be disassembled by loosening the screw fasteners, enabling quick replacement of the magnetic element 300, avoiding the thermal damage risks associated with traditional welding methods.

In a further alternative, the connecting element 400 includes a threaded fastener 410 and a connecting nut 420. A nut installation groove 2111 is provided on the side of the connecting through hole 211, away from the magnetic element 300. The connecting nut 420 is accommodated in the nut installation groove 2111 and is prevented from rotating. The threaded fastener 410 passes through the mounting through hole 320 and the connecting through hole 211, and engages in a threaded connection with the connecting nut 420 to fix the magnetic element 300. With this configuration, during assembly, the connecting nut 420 is pre-embedded in the nut installation groove 2111, preventing rotation, and the operator can tighten the threaded fastener 410 with one hand to complete the locking process, eliminating the need to fix the nut in narrow spaces and greatly improving assembly efficiency. During use, the axial pre-tension generated by the engagement of the threaded fastener 410 and the connecting nut 420 makes the magnetic element 300 tightly pressed against the bottom surface of the installation groove 210, thoroughly eliminating micron-level gaps under the vibrating environments ensuring the transmission of the pull force greater than 40 kg without loss. During maintenance, simply loosening the threaded fastener 410 allows separation of the magnetic element 300, and the connecting nut 420 remains in the nut installation groove 2111, avoiding loss, enabling quick maintenance in 10 seconds.

In yet another alternative, the connecting element 400 is a threaded fastener 410. The bottom of the installation groove 210 is provided with a connecting protrusion 212, which is integrally formed with the base 200. A blind hole 2121 with internal threads is formed at the top of the connecting protrusion 212. The threaded fastener 410 passes through the installation through hole 320 and is screwed into the blind hole 2121 with internal threads, thereby fixing the magnetic element 300 to the installation groove 210. With the above structure, during assembly, the threaded fastener 410 is directly screwed into the blind hole 2121 with internal threads of the connecting protrusion 212, which is integrally formed with the base 200. This eliminates the need for a pre-installed nut, realizing single-piece, one-handed locking in 30 seconds, improving assembly efficiency by 50% compared to the separate nut solution. During use, the rigid substrate of the connecting protrusion 212 resists vibration and torsional loads, and the interface between the internal threads of the blind hole 2121 and the threaded fastener 410 generates continuous axial clamping force, ensuring that the magnetic element 300 is tightly attached to the bottom surface of the installation groove 210, ensuring a low-loss transfer of 40 kg-level tensile force and preventing vibration-induced noise. During maintenance, the magnetic element 300 can be separated by simply unscrewing the threaded fastener 410. The integrated connection eliminates the risk of small parts of the connecting protrusion 212 being lost.

In this embodiment, an auxiliary adhesive layer is arranged between the contact interface of the installation groove 210 and the magnetic element 300, which enhances the vibration resistance performance. With the above structure, during installation, the magnetic element 300 is embedded into the installation groove 210, and the auxiliary adhesive layer fills the contact interface between them. During use, when the device is under vibrating conditions the auxiliary adhesive layer can buffer the forces caused by the vibration, reducing friction and loosening between the installation groove 210 and the magnetic element 300. In conjunction with the magnetic attraction of the magnetic element 300, the overall vibration resistance of the structure is further improved, ensuring that the magnetic element 300 is firmly installed and preventing connection failure due to vibration, ensuring stable operation in vibrating scenarios.

In this embodiment, the base 200 includes a fan installation part 220, and the fan assembly 100 includes a fan bracket 110, which is integrally formed with the fan installation part 220. With the above structure, the fan bracket 110 is integrally formed with the fan installation part 220, making the connection between the fan assembly 100 and the base 200 more stable. During the operation of the magnetic suction fan, it effectively reduces wobbling and displacement between the two parts, ensuring the stability of fan operation. Additionally, the one-piece design eliminates the assembly step between the two parts, simplifying the manufacturing process, reducing assembly costs and the risk of errors, and improving production efficiency. Moreover, this structure can enhance the overall structural strength, extend the product's service life, and provide users with a more reliable experience.

In this embodiment, the fan assembly 100 further includes a fan body 120, which is rotatably connected to the fan bracket 110. With the above structure, during use, the fan body 120 can rotate around the fan bracket 110, allowing for a continuous 360° adjustment of the airflow angle, precisely directing airflow to the golf cart driver or passengers, avoiding air flow waste. During driving, a damping mechanism is built into the rotating connection of the fan body 120, resisting fan shaking caused by road bumps and maintaining the stability of the set angle, ensuring a continuous and uniform airflow. When not in use, the fan body 120 can be rotated towards the base 200 to reduce the risk of external collision damage and simultaneously reduce space occupancy.

In this embodiment, the base 200 further includes a fan clamp body 230, which is rotatably connected to the fan installation part 220. With the above structure, during use, the fan clamp body 230 can be rotated to adjust the relative angle between the fan clamp body 230 and the fan installation part 220, adapting to different clamping scenarios, such as horizontal desktops or vertical railings, enhancing the product's applicability. Users can fix the fan clamp body 230 in an appropriate position according to their needs, keeping the fan body 120 in a stable airflow state, providing a continuous and comfortable experience. During storage, the fan clamp body 230 can be rotated to a position where it fits with the base 200, reducing the product's occupied space, making it easy to carry and store.

In this embodiment, the magnetic element 300 is a countersunk pot magnet, which includes:
a) a permanent magnet made of sintered neodymium iron boron material;
b) a steel housing that encloses sidewalls and a bottom surface of the permanent magnet and forms a single-sided magnetic working surface 310;
c) a countersunk hole located at a center of the steel housing, the countersunk hole having a taper configured to match a threaded fastener 410 for fixing the countersunk pot magnet flush with the base.

With the above structure, during use, the permanent magnet made of sintered neodymium iron boron material provides strong and stable magnetic attraction force. The steel housing covering the sidewalls and bottom surface of the permanent magnet not only protects the permanent magnet from external impact and corrosion, extending its service life, but also concentrates the magnetic field lines on the single-sided magnetic working surface 310, enhancing the magnetic attraction force on this side. This allows the magnetic element 300 to firmly attach to a ferrous surface, ensuring that the fan does not easily shift during operation. The design of the countersunk hole, which matches the cone angle of the threaded fastener 410, ensures that the countersunk pot magnet is fixed flush with the base 200, ensuring the flatness of the base surface, preventing protruding elements from affecting the magnetic suction fan's placement or storage, and allowing the magnetic element 300 to tightly integrate with the base 200, improving the overall structural stability. When storing or relocating, the magnetic suction fan can be easily detached from the adsorption surface by overcoming the magnetic attraction force with external force, making operation simple and convenient, improving the magnetic suction fan's flexibility and portability.

In this embodiment, the base 200 is also provided with an anti-slip element 240, which is arranged around the magnetic element 300. With the above structure, during use, the anti-slip element 240 arranged around the magnetic element 300 comes into contact with the placing surface, increasing the friction between the base 200 and the placing surface. Even when the fan generates slight vibrations or the placing surface is uneven, the anti-slip element 240 effectively prevents the base 200 from sliding, ensuring the fan remains stable, preventing displacement from affecting the airflow effect. At the same time, the anti-slip element 240 can reduce the friction noise between the base and the placing surface during fan operation, improving comfort and providing a reliable user experience.

In this embodiment, the anti-slip element 240 includes an installation surface 241 and an anti-slip surface 242. The installation surface 241 is fixedly connected to the base 200, such that the anti-slip surface 242 slightly extends beyond the magnetic working surface 310. With the above structure, during installation, the anti-slip surface 242 slightly extends beyond the magnetic working surface 310 (typically by 0.1-0.5 mm), initially undergoing compressive deformation during magnetic contact, providing pre-friction positioning and preventing misalignment caused by the sliding of the magnet. During driving vibrations, the high friction coefficient of the anti-slip surface 242 (μ ≥ 0.8) generates shear resistance with the placing surface, working together with the magnetic attraction to resist lateral inertia impacts, eliminating the micro-slippage phenomena under the vibration conditions. In water or slippery conditions, the micro-protrusions of the anti-slip surface 242 pierce through the water film, forming physical adsorption points and maintaining a friction coefficient greater than 0.6 (an increase of 300% compared to a smooth magnetic surface), thus preventing adhesion failure in rainy conditions.

In this embodiment, at least one magnetic element 300 is provided. With the above structure, in lightweight scenarios, a single magnetic element 300 can provide a planar pull force greater than 10 kg, meeting the fixation requirements for ferromagnetic planes in typical vibrating environments. The base structure 200 is simplified and reduced by 30%, reducing the installation burden. In high-intensity vibration scenarios, a redundant array of magnetic elements 300 can be formed (e.g., dual-magnet solution), and the total adsorption force exceeds 20 kg, resisting the inertial shock caused by sharp deceleration on steep slopes and thus eliminating displacement accumulation risks.

In this embodiment, the planar pull force provided by the magnetic working surface 310 is greater than 40 kg to better meet the need for maintaining the fixation of the base 200 under high-intensity vibration conditions. With this structural setup, in extreme vibration conditions, the planar pull force provided by the magnetic working surface 310, which is greater than 40 kg, creates an absolute adsorption advantage, resisting 5G impact acceleration (measured value) generated in high-intensity shaking scenarios, further reducing the micro-displacement risk of the base 200. In long-duration driving, the 40 kg adsorption force threshold suppresses the cumulative effect of high-frequency micro-vibrations, ensuring that the base 200 remains fixed without slip for 8 hours continuously (measured data), avoiding the loosening hazard caused by adsorption force decay in traditional solutions. Under extreme vibration conditions, redundant magnetic attraction force reserves (e.g., 60 kg sub-surface pot magnets) resist combined stresses such as a 40° slope deceleration or heavy rain and slippery surfaces, maintaining 100% effective fixation, preventing safety accidents due to equipment falling. Measured data shows that when the planar pull force provided by the magnetic working surface 310 is less than 10 kg, it cannot meet the adsorption requirements of the magnetic suction fan in vibrating conditions. When the planar pull force exceeds 10 kg, it can meet the adsorption requirements for normal vibrating conditions; when the planar pull force exceeds 40 kg, it can meet the adsorption requirements for high-intensity shaking scenarios.

In this embodiment, the fan body 120 includes a fan snap-fit portion 121 and a mating snap-fit portion 122, and the fan bracket 110 is provided with a bracket installation part 111. The fan snap-fit portion 121 and the fan bracket 110 are rotatably connected by the mating snap-fit portion 122. Through the setup of this structure, during use, the fan snap-fit portion 121 of the fan body 120 is rotatably is rotatably connected to the bracket installation part 111 of the fan bracket 110 via the mating snap-fit portion 122, allowing the fan body 120 to rotate flexibly relative to the fan bracket 110. Users can adjust the airflow direction of the fan body 120 to direct the airflow more precisely towards the target area, improving comfort. This rotatable connection also facilitates operation when adjustments or storage are needed, enhancing the flexibility and convenience of the magnetic suction fan, and further improving the user's experience.

In this embodiment, the fan body 120 further includes a control circuit board 123, a rechargeable power supply 124, and a charging port 125. By this structural arrangement, during use, the rechargeable power supply 124 provides power to the control circuit board 123 and the fan body 120’s operation, without relying on an external power supply, enabling the fan body 120 to be used flexibly in various scenarios and improving portability. The control circuit board 123 effectively regulates the operation of the fan body 120, such as adjusting wind speed, controlling start/stop, etc., to meet different user needs. When the rechargeable power supply 124 is low, it can be recharged via the charging port 125 by connecting to an external power supply, ensuring that the rechargeable power supply 124 can continue to supply power and the fan body 120 can operate normally, providing a stable and convenient user experience. During daily use, the rechargeable power supply 124 intelligently allocates power via the control circuit board 123, driving the fan to operate continuously for more than 8 hours, meeting the cooling needs for all-day operations or outdoor activities (e.g., long construction periods, off-road driving, busy farming work). During charging maintenance, the charging port 125 supports both 12V car direct charging and universal serial bus-power delivery (USB-PD) fast charging modes, with a 50% energy supplement in 30 minutes (speeding up 300% compared to traditional solutions), completing energy replenishment during equipment rest or work breaks. In emergency scenarios, the control circuit board 123 intelligently isolates charging and discharging, automatically switching to a safe standby mode when the power is exhausted, preventing over-discharge damage, and ensuring 2000 charge cycles.

In this embodiment, the fan body 120 also includes a discharge port 126. With this structural arrangement, during use, the discharge port 126 of the fan body 120 serves an additional power supply function. When small electronic devices (such as mobile phones, handheld distance meters, walkie-talkies, recorders, etc.) nearby run out of power, the fan body 120 can be connected to these devices via the discharge port 126. At this time, the rechargeable power supply 124 in the fan body 120 can deliver power to external devices through the discharge port 126, solving the emergency power issue. This structure makes the fan body 120 not only a fan but also a portable emergency power supply, significantly enhancing the magnetic suction fan's overall practicality, offering more convenience and security for use in vibration conditions (e.g., engineering operations, off-road driving, farming activities) and various outdoor scenarios. The discharge port 126, controlled by the control circuit board 123, draws power from the rechargeable power supply 124, maintaining the magnetic suction fan’s basic airflow while discharging, achieving “cooling + power supply” dual functions with zero interruption (prioritizing the minimum power consumption required for the fan assembly 100’s airflow).

In this embodiment, the fan body 120 further includes at least one control button 127. With this structural arrangement, the control button 127 provides users with an intuitive interface. Users can control various functions of the fan body 120 by pressing different control buttons 127 and adjust the magnetic suction fan’s settings according to their needs, improving convenience. Meanwhile, the multiple control buttons 127 correspond to different functions, preventing operational confusion and further enhancing the flexibility and reliability of the product. In fact, this embodiment also includes a light strip 128, a motor 129, and fan blades 1210, with the light strip 128 placed between the motor 129 and the fan blades 1210. The control buttons 127 include a wind speed control button, a wind time control button, and a light control button. The wind speed control button (including three levels: 1, 2, and 3) allows the user to adjust the magnetic suction fan’s wind strength by controlling the motor's speed, thereby adjusting the fan blades' rotation speed and achieving flexible wind strength adjustment for different scenarios. The wind time control button (including 2-hour, 4-hour, and 6-hour timing) implements a timing function, allowing users to pre-set the fan’s operation duration, automatically stopping the fan after the set time, saving energy and avoiding the hassle of manual shutdown. The light control button (with brightness levels of 30%, 60%, and 100%) adjusts the light's brightness, allowing the user to choose the appropriate brightness based on environmental lighting or personal preference, enhancing comfort. This targeted button arrangement makes the operations clear and understandable, enabling users to get started quickly and effectively avoiding confusion, significantly enhancing the product's flexibility, convenience, and user-friendly experience.

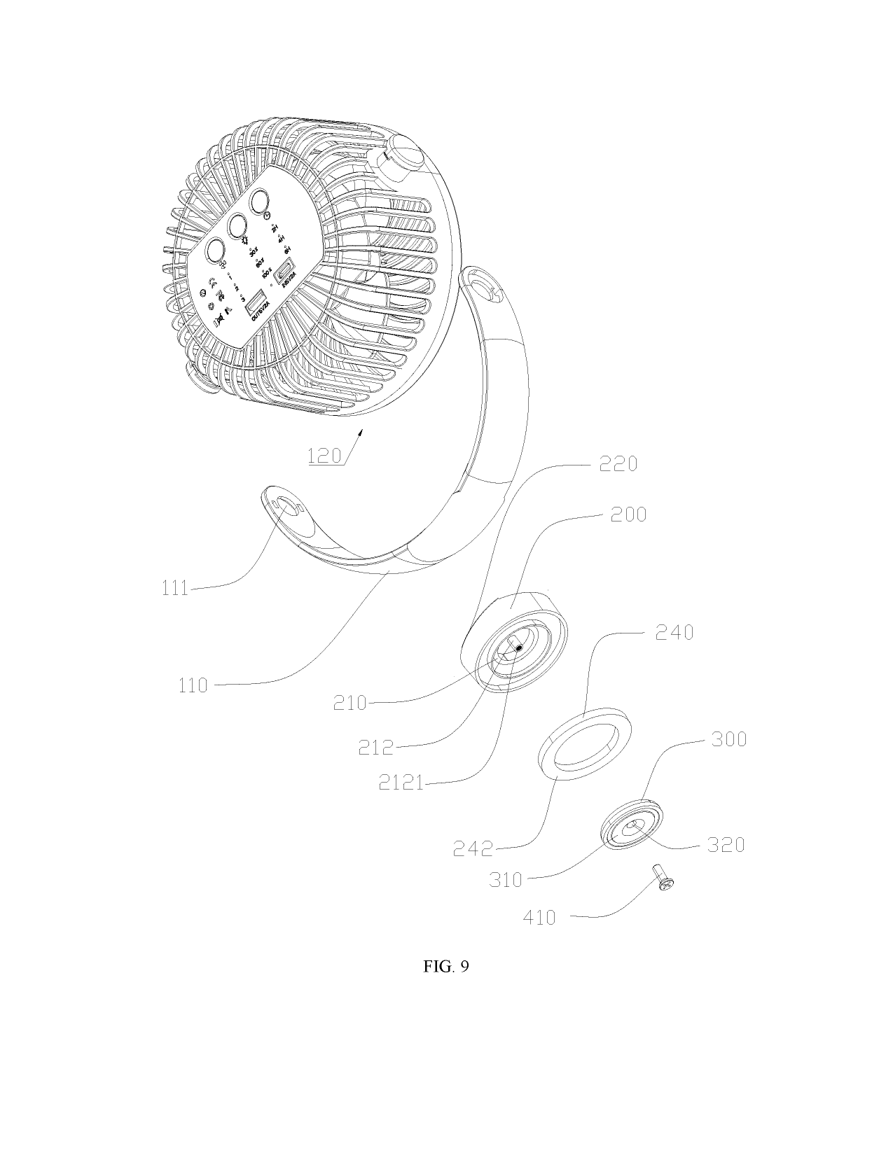

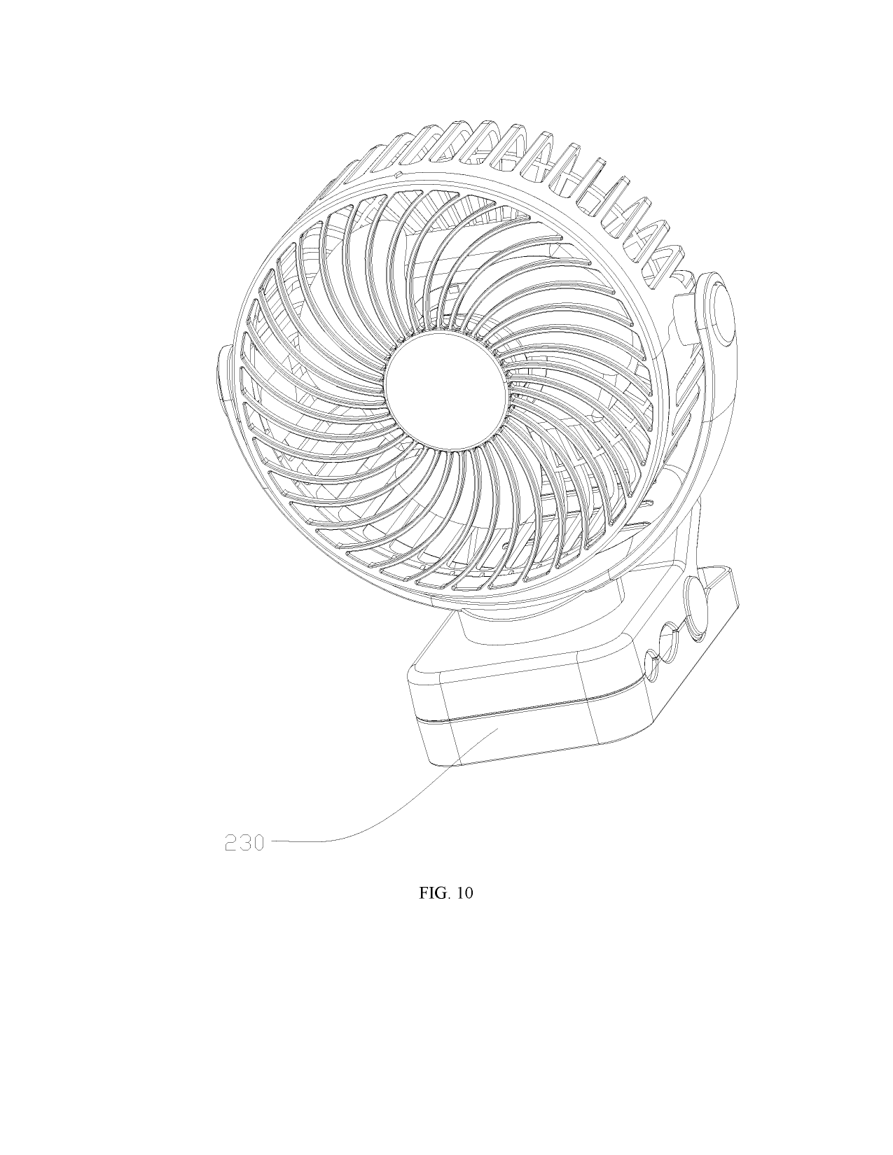

FIGS. 1-7 illustrate the structural schematic views of the magnetic suction fan of the first embodiment of the present disclosure, where the connection through hole 211 is provided in the installation groove and the magnetic element 300 is installed on the base 200 via the connecting element 400. FIGS. 8-9 illustrate the structural schematic views of the magnetic suction fan of the second embodiment, where the installation groove is provided with the connection protrusion 212, and the threaded blind hole 2121 is located in part of the connection protrusion 212, through which the magnetic element 300 is installed on the base 200 via the connecting element 400. FIGS. 10-12 illustrate the structural schematic views of the magnetic suction fan of the third embodiment, where the fan installation part 220 and the installation groove 210 are provided with the fan clamp body 230, and two magnetic elements 300 are used, differing from the first embodiment.

The embodiments provided above are for illustration purposes, and the invention is not limited to these specific embodiments. Any modifications, substitutions, or technical developments based on the concept of the invention shall fall within the scope of the present disclosure.

What is claimed is:

1. A magnetic suction fan, comprising:
a fan assembly configured to convert electrical energy into mechanical energy to generate airflow;
a base rigidly fixed to the fan assembly; and
a magnetic element exposed on the base, configured to magnetically secure the base to a ferromagnetic surface;
wherein the magnetic element comprises a magnetic working surface with a magnetic attraction force sufficient to maintain the base fixed under vibration conditions.

2. The magnetic suction fan according to claim 1, wherein the base is provided with an installation groove having an embedded edging structure;
wherein the installation groove is shaped to match an outer contour of the magnetic element; and
the magnetic element is embedded in the installation groove and fixed therein; and
the installation groove forms a circumferential enclosure around the outer contour of the magnetic element.

3. The magnetic suction fan according to claim 2, wherein the magnetic suction fan further comprises a connecting element, wherein the magnetic element is fixedly installed in the installation groove via the connecting element.

4. The magnetic suction fan according to claim 3, wherein the magnetic element is provided with an installation through hole, and the connecting element passes through the installation through hole and is fixedly connected to the installation groove.

5. The magnetic suction fan according to claim 4, wherein the magnetic element is a countersunk pot magnet, the countersunk pot magnet comprises:
a permanent magnet made of sintered neodymium iron boron material;
a steel housing that encloses sidewalls and a bottom surface of the permanent magnet and forms a single-sided magnetic working surface; and
a countersunk hole located at a center of the steel housing, the countersunk hole having a taper configured to match a threaded fastener for fixing the countersunk pot magnet flush with the base.

6. The magnetic suction fan according to claim 4, wherein a bottom of the installation groove is provided with a connecting through hole, and the connecting element passes through both the installation through hole and the connecting through hole and is threadedly fastened to secure the magnetic element within the installation groove.

7. The magnetic suction fan according to claim 6, wherein the connecting element comprises a threaded fastener and a connecting nut; one side of the connecting through hole away from the magnetic element is provided with a nut installation groove;
wherein the connecting nut is accommodated within the nut installation groove and prevented from rotating; the threaded fastener sequentially passes through the installation through hole and the connecting through hole, and is threadedly connected to the connecting nut to secure the magnetic element.

8. The magnetic suction fan according to claim 4, wherein the connecting element is a threaded fastener, and the bottom of the installation groove is provided with a connecting protrusion, which is integrally formed with the base, and a top of the connecting protrusion defines a blind hole having internal threads,
wherein the threaded fastener passes through the installation through hole and is screwed into the blind hole to fix the magnetic element within the installation groove.

9. The magnetic suction fan according to claim 8, wherein an auxiliary adhesive layer is disposed between a contact interface of the installation groove and the magnetic element, the auxiliary adhesive layer being configured to enhance vibration resistance.

10. The magnetic suction fan according to claim 1, wherein the base comprises a fan installation part, and the fan assembly comprises a fan bracket, wherein the fan bracket is integrally formed with the fan installation part.

11. The magnetic suction fan according to claim 10, wherein the fan assembly further comprises a fan body, the fan body is rotatably connected to the fan bracket.

12. The magnetic suction fan according to claim 11, wherein the base further comprises a fan clamp body, the fan clamp body is rotatably connected to the fan installation part.

13. The magnetic suction fan according to claim 1, wherein the base further comprises an anti-slip element, which is arranged around the magnetic element.

14. The magnetic suction fan according to claim 13, wherein the anti-slip element comprises an installation surface and an anti-slip surface, wherein the installation surface is fixedly connected to the base, and the anti-slip surface extends beyond the magnetic working surface.

15. The magnetic suction fan according to claim 14, wherein at least one magnetic element is provided.

16. The magnetic suction fan according to claim 1, wherein the magnetic working surface provides a plane pull force exceeding 40 kg, to ensure the base remains fixed under the vibration conditions.

17. The magnetic suction fan according to claim 11, wherein the fan body comprises a fan snap-fit portion and a mating snap-fit portion, the fan bracket is provided with a bracket installation portion, and the fan snap-fit portion and the fan bracket are rotatably connected via the mating snap-fit portion.

18. The magnetic suction fan according to claim 11, wherein the fan body further comprises a control circuit board, a rechargeable power supply, and a charging port.

19. The magnetic suction fan according to claim 18, wherein the fan body further comprises a discharge port.

20. The magnetic suction fan according to claim 11, wherein the fan body further comprises at least one control button.
